(19) United States
(12) Patent Application Publication
(10) Pub. No.: US 2014/0127039 A1
(43) Pub. Date: May 8, 2014

(54) ALCOHOL FUEL-POWERED ELECTRIC PUMP AND SETTING METHOD FOR SAME

(71) Applicants: Lisheng Sun, Nanjing (CN); Guoqing Chen, Nanjing (CN)

(72) Inventors: Lisheng Sun, Nanjing (CN); Guoqing Chen, Nanjing (CN)

(73) Assignee: LISHENG SUN, Nangjin, Jiangsu (CN)

(21) Appl. No.: 14/125,064

(22) PCT Filed: Jul. 5, 2012
(86) PCT No.: PCT/CN2012/078227

§ 371 Date: Dec. 9, 2013

(30) Foreign Application Priority Data
Jul. 13, 2011 (CN) 201110195313.3

(51) Int. Cl. F02M 37/08

(52) U.S. Cl. CPC F02M 37/08
USPC 417/53; 417/410.1; 417/411

(57) ABSTRACT

A setting method for an alcohol fuel-powered electric pump is used for an alcohol fuel-powered electric pump, wherein the operating voltage of the electric pump is set at 6-10.4 V and is used for an alcohol fuel-powered motor vehicle the output direct current operating voltage of which is 7 V-9 V or greater than 9 V but less than 10.4 V. The number of turns of the rotor coils of the drive motor of the alcohol fuel-powered electric pump is deliberately reduced by 15-50%. The setting method can greatly reduce the corrosion of the pump by electro-chemical reactions when operating, for example, a fuel pump with an operating voltage of 8-8.9 V can be employed, the operating life thereof can fully meet the usage requirement of a generator and yet the drawback of blocked filters and oil nozzles can essentially be eliminated.

### FIELD OF THE INVENTION

The invention related the setting method and apparatus for an alcohol fuel-powered electric pump is used for an alcohol fuel-powered electric pump.

### BACKGROUND OF THE INVENTION

The fuel-powered pump is used for electronic fuel injection system for vehicle fuel supply power. China National standardization administration of Jul. 2, 2009 reported, the vehicles with methanol-gasoline (M85) promulgated standards formally approved and implemented. It is understood that this standard is the first product of methanol-gasoline standards. Methanol-gasoline (such as M85, M60) or a pure methanol (M100) is the economic fuel to replace gasoline. Methanol-gasoline and other alcohol fuels (ethanol) can fully use on the existing car engines. That existing cars can use a single methanol fuel drive and start only when cold starts with a small number of gasoline combustion; use of methanol gasoline or other alcohol fuel ethanol gasoline fuel supply is with existing auto electric fuel injection and fuel supply system of interlinked, which are made of exactly the same structure built in fuel electric pump. In addition, Shanxi, Wuhan and other places of China have begun to mass adoption of a single methanol fuel used in taxis, to ease rising gasoline prices—taxi driver has been unable to afford fuel costs.

Due to methanol for weak conductive of polar solvent, which and inevitable containing water, so has theory think methanol easy by oxidation dehydrogenation and into formaldehyde, so fuel-powered electric pump in methanol within was of corrosion far than in petrol within; its main performance of fuel-powered electric pump will produced stick heavy form material, very easy jam filter network and spray nozzle. There are electrolytic corrosion of fuel-powered electric pump.

The power terminal connector, carbon brush, copper commutator of fuel-powered electric pump soaking in methanol tank arising serious electrolytic chemical corrosion. work of fuel-powered electric pump will produces formaldehyde, carboxylic acid, carboxylic acid copper and stick material, and makes methanol serious discoloration turned sour, its generated property of electrolytic corrosion very easy jam filter network and spray nozzle and the damaged oil bit sensor. Carboxylic acid, formaldehyde will makes car oxygen sensor chronic poisoning, and formaldehyde of emissions also will serious pollution environment. It is reported methanol engine exhaust makes vegetation wither. Overall, methanol engine cannot normal work is general opinions.

Xu Chunliang article “high proportion methanol gasoline on electric fuel pumps for corrosive analysis” gives a wide variety of corrosion phenomena are described the corrosive effect. (see http://www.docin.com/p-69691304.htiTil), which dealt in methanol in the presence of water and oxygen in copper (including copper wire and copper commutator) methanol is discoloration because of copper (electrolysis later) oxidation of two-valent copper ions. Under the working of methanol and gasoline, but have not reached a solution of methanol corrosion to fuel-powered electric pump.

Fang Linyan make corrosion-resistant anode (CN200720306381) in fuel-powered electric pump, seems to reveal the presence of complex electrochemical corrosion in the methanol. In order to protection fuel-powered electric pump, outside of fuel-powered electric pump plus the second anode, between the first anodes of fuel-powered electric pump and the second anode connection of an additional power supply, used to relieve the Anodic electrochemical precipitation. But high voltage electrolytic chemical reactions just exacerbates, its adhesive or glue precipitation may increase exponentially worsened working conditions of the engine.

Currently, work life of fuel-powered electric pump can reached 8,000 hours above, but in methanol fuel in using fuel-powered electric pump (rated voltage callout for 12V, actual imposed of voltage most common for 14.5V), because electric chemical corrosion of effects, makes engine appeared variety and methanol electrolytic reaction generated adhesive or glue property associated of machinery fault, so after more than 30 years of efforts, and methanol car is has been cannot entered practical stage.

### SUMMARY OF THE INVENTION

The invention to solve the technical problem, proposed method for an alcohol fuel-powered electric pump and apparatus. In particular, could dramatically slow the methanol electrochemical corrosion, increase life of fuel-powered electric pump in methanol alcohol.

This invention solve technical problems using a technical solution is:

A setting method for an alcohol fuel-powered electric pump, wherein the operating voltage of the electric pump is set at 6-10.4 V.

Wherein the operating voltage of the electric pump is set at 9-10.4V.

Wherein the operating voltage of the electric pump is set to be higher than 7V and lower than 9V.

Wherein the operating voltage of the electric pump is set to be higher than 8V and lower than 9V.

Wherein the electric pump is used in alcohol fuel motor vehicles with DC output that is higher than 7V and lower than 9V, or higher than 9V and lower than 10.4V.

An alcohol fuel-powered electric pump, wherein the number of coils on the rotor of the motor for the electric pump is lowered by 15-50%.

An alcohol fuel-powered electric pump, wherein the operating voltage motor of the alcohol-fuel pump is set between 6V-10.4V, and the number of coils or the diameter of the wires in the rotor of the fuel pump is adjusted accordingly, so that the power output of the fuel pump is operating at 6-10.4V is the same as when operating at 14V.

Wherein a voltage transformation module is installed outside the fuel tank, connecting the DC power of the vehicle to the alcohol-fuel electric pump, and the voltage transformation module is a DC/DC buck converter or high power rating resistance, allowing the motor of the methanol fuel pump to operate at 6V-10.4V.

Wherein the operating voltage of the motor of the methanol fuel pump is 7-9V.

wherein the DC power for the alcohol-fuel electric pump is provided by the tapping of the low voltage winding of the dedicated generator of the motor vehicle, or the tapping of the battery plates; the battery plates having center tapping, providing power from the third or fourth grid from the negative terminal of the battery, and the output voltage being 6-7V or 8-9.33V.

When the existing generators charging high voltage. A design based on the above setting method of the alcohol-fuel electric pump installation, unit contains the fuel pump voltage transformation module. Voltage transformation module settings in alcohol fuel outside the box, connected in the car of DC power supply system and between alcohol fuel engine fuel pump, voltage transformation modules can be either DC/DC step-down converters or high power rating resistance, making the alcohol-fuel electric pump drive motor operating voltage of 6V-10.4V: choose 8V-9V; At the same time, the alcohol-fuel electric pump (hereinafter referred to as methanol pump) drive motor rotor winding turns when the in the number of turns of the coil is 85%-50% of the fuel pump is operating at 14V, or methanol pump drive motor rotor winding diameter of enameled wire is 1.1-2.3 times than in diameter.

The number of coils or the diameter of the wires in the rotor of the alcohol-fuel electric pump is adjusted accordingly, so that the power output of the alcohol-fuel electric pump is operating at 6-10.4V is the same as when input at 14V.

The alcohol-fuel electric pump installation as described, if car (ship) of DC power supply system provides 6V-10.4V power directly to the alcohol-fuel electric pump, you can omit the voltage transformation module. DC power supply system of cars (ship) can derived from motor vehicles specially dedicated generators of low voltage winding is tapped or motor vehicles specially tapped connections of the battery plates. The alcohol-fuel electric pump in particularly as Methanol pump unit, can apply to 100% of alcohol fuel, or any proportion of the methanol (alcohol) fuel blends.

Current automotive standard operating voltage of the 13.8V-14.5V (nominal 12V), in which methanol exposed conductors will continuous electrolytic chemical reactions, severe discoloration makes methanol sour, black metal surface, and associated the viscous liquid under operating voltage. But after a long trial found that as long as the DC voltage is less than 10.5V, then the methanol electrochemical reaction speed will be slowed considerably, so the invention to a methanol pump operating voltage range of 6V-10.4V, between the optimal voltage for 8V-9V. Practical tests also confirmed that working life is several times over at voltage for 8V-9V instead of methanol pump using the 13.8V-14.5V range of voltage.

The beneficial effects of the invention is: by reducing the methanol pump working voltage, you can slow the electrolytic chemical reactions, thus completely eliminating adhesive or glue precipitation, high voltage applied electrolysis producing formaldehyde, formic acid and electrolytic polymerization further, thereby reducing the methanol serious consequences of corrosion of the pump to the engine.

Methanol pump of high voltage to oil level sensor, electronic fuel injection system will also brought great damage to the oxygen sensor and the controller.

Low voltage, due to reduced adhesive or glue precipitation, the operating life thereof can fully meet the usage requirement of methanol pump and yet the drawback of blocked filters and oil nozzles can essentially be eliminated.

Testing has also proven at the same distance between the electrodes applied DC voltage is 6V, then become stop methanol electrochemical corrosion.

### DETAIL DESCRIPTION OF THE INVENTION

Case studies on the implementation of the present invention is a pump of methanol as descriptions, experiments using M100 pure methanol, methanol gasoline similarly applicable to the invention of the M15-M85. This principle fully applies to ethanol (E20 or grade), also called ethanol pumps.

Experiment found: in methanol in the through to 14V DC voltage, after ten hours about, methanol will produced very strong of electrolytic reaction, color from water transparent into thick yellow tea color, anode appeared obvious blue powder wool objects (should for bivalent copper ion); from mechanism, then methanol in 14V of voltage to copper wire and power pick plug-in of methanol pump produced very strong electric chemical corrosion, and from reasoning these electrolytic chemical reactions and the generated objects of accumulated and produced has more strong of corrosion conditions (Electrolytic oxidation of carboxylic acid). Including methanol in the presence of water and oxygen are likely to work for the power of copper (including copper wire and copper commutator) have a significant role in electrochemical corrosion, corrosion of long multi-strand copper conductors can be completely broken. 7V-9V voltage conditions, this situation can be avoided, when considering the actual use of pump life can reach more than 3,000 hours with plenty of practical, so that the invention can be used in the following manner:

Embodiment 1: embodiment, pump application system is application of methanol (alcohol) fuel for motor vehicles (ships), including motor vehicles (ships), power supply, power supply module, as well as installed in motor vehicle fuel tank. Assembly the power connectors, and pump unit. Motor vehicles generator power output usually around 14V. The power supply module connected to the methanol pump and motor power supply (must be placed in the fuel tank), reduce the output voltage between 6V-10.4V, methanol pump provide the methanol at appropriate operating voltage. In this embodiment, the power supply module for DC/DC step-down converter, car about 14V to lower the voltage of 9V, delivered to the methanol fuel tank supply methanol pump as working power source. We adjust number of turns of the rotor coil of methanol pump. Fuel pump (methanol pump) is 38 mm in diameter, for example, the original drive motor rotor coils from 17 turns reduced to 14 turns, reduce after 3 laps into a dedicated methanol pump in the invention.

In application this implementation cases of methanol pump, first, according to engine on pump of flow needs, will reduced fuel pump rotor circle number to 11-16 circle of turns number, makes its became low voltage methanol pump, again will methanol pump installed to motor vehicle of fuel tank for corresponds to of pipeline connection, then, will DC/DC buck installed in methanol pump and motor vehicle power output.

When vehicles around 14V power supply output voltage, DC/DC step-down the voltage down to 9V or so (between 7V-10V) for methanol pump. At the same time, due to lower methanol pump rotor winding of coils, improves operating current, make sure that the fuel pump power output unchanged. Because by reducing voltage, substantially delaying the electrochemical reaction of methanol resulting from the power voltage, and thus substantially delaying the serious corrosion on methanol pump. Experiment in hundreds of hours, almost no alcohol change color and viscous precipitation. Significantly reduced methanol electrochemical reaction glue precipitates, clogging filters and damaged nozzle and oil level sensor basically eliminated.

Embodiment, the voltage is 9V, M100 pure methanol fuel used, the methanol pump has run continuously for more than 3,000 hours, methanol pump without any trouble.

Embodiment 2: the embodiment of the power supply module can be replaced by 1 Ohm resistor of high power rating (General depending on the current selection high power rated resistor, between 0.5-1.5 ohms). The resistor connected in series circuit of the methanol pump, depending on the current size of the methanol pump, the pressure drop when the current through the resistor is used, working voltage of 9V. Which have the same effect as Embodiment 1. Methanol pump connected in series a resistance of 1 ohm, output voltage is 8V, M85 methanol fuel used, and the appliance run continuously for more than 3,000 hours, methanol pump and engine without any trouble.

Embodiment 3: the embodiment of power directly to the low voltage power supply. The low voltage power supply directly from the motor-generator is intended for low voltage windings connected output, or motor vehicle using a special dedicated battery connection output, pump components provide for methanol 6V-10.4V operating voltage. This type of storage battery for the three power outputs. The experimental results similar as embodiment 3.

Embodiment 4: as embodiment 1, methanol pump driving circuit used brushless motor pump component (by control the frequency of the stator rotating magnetic field). The same work voltage around 9V, methanol electrochemical corrosion will also significantly reduce.

Embodiment 5: Center tap batteries specially made for methanol pump, starting from the negative terminal third or fourth output voltage taps of batteries, if generator recharge batteries, its output voltage is 7V or 9.33V.

These embodiments of electricity experiment of methanol, found the appropriate scope of work and, in addition, vehicle testing also shows that the above result. When the pump components in methanol and 7V supply voltage, normal working hundreds of hours without obvious signs of corrosion, or electrochemical reaction glue precipitates appeared. Voltage drops significantly could slow the methanol electrochemical corrosion. Methanol Pump device is suitable for 100% methanol fuel, or any proportion of the methanol (alcohol) fuel and fuel blends. Above, this invention will set methanol pump of work voltage in lower of value, makes methanol pump of work life significantly extended.

This invention will also reduce damage to engine while using methanol fuel.

1. A setting method for an alcohol fuel-powered electric pump is used for an alcohol fuel-powered electric pump, wherein the operating voltage of the electric pump is set at 6-10.4 V and is used for an alcohol fuel-powered motor vehicle.

2. A setting method for an alcohol fuel-powered electric pump according to claim 1, wherein the operating voltage of the electric pump is set at 9-10.4V.

3. A method according to claim 1, wherein the operating voltage of the electric pump is set to be higher than 7V and lower than 9V.

4. A method according to claim 1, wherein the operating voltage of the electric pump is set to be higher than 8V and lower than 9V.

5. A method according to claims 1, wherein the electric pump is used in alcohol fuel motor vehicles with DC output that is higher than 7V and lower than 9V, or higher than 9V and lower than 10.4V.

6. An alcohol fuel-powered electric pump, wherein the number of coils on the rotor of the motor for the electric pump is lowered by 15-50%.

7. An alcohol fuel-powered electric pump, wherein the operating voltage 6V-10.4V, and the number of coils or the diameter of the wires in the rotor of the fuel pump is adjusted accordingly, so that the power output of the fuel pump is operating at 6-10.4V is the same as when operating at 14V.

8. An alcohol fuel-powered electric pump according to claim 6, wherein a voltage transformation module is installed outside the fuel tank, connecting the DC power of the vehicle to the alcohol-fuel electric pump, and the voltage transformation module is a DC/DC buck converter or high power rating resistance, allowing the motor of the methanol fuel pump to operate at 6V-10.4V.

9. An alcohol fuel-powered electric pump according to claim 6, wherein the operating voltage of the motor of the methanol fuel pump is 7-9V.

10. An alcohol fuel-powered electric pump according to claim 6, wherein the DC power for the alcohol fuel electric pump is provided by the tapping of the low voltage winding of the dedicated generator of the motor vehicle, or the tapping of the battery plates; the battery plates having center tapping, providing power from the third or fourth grid from the negative terminal of the battery, and the output voltage being 6-7V or 8-9.33V.

11. An alcohol fuel-powered electric pump according to claim 7, wherein a voltage transformation module is installed outside the fuel tank, connecting the DC power of the vehicle to the alcohol-fuel electric pump, and the voltage transformation module is a DC/DC buck converter or high power rating resistance, allowing the motor of the methanol fuel pump to operate at 6V-10.4V.

12. An alcohol fuel-powered electric pump according to claim 7, wherein the operating voltage of the motor of the methanol fuel pump is 7-9V.

13. An alcohol fuel-powered electric pump according to claim 7, wherein the DC power for the alcohol fuel electric pump is provided by the tapping of the low voltage winding of the dedicated generator of the motor vehicle, or the tapping of the battery plates; the battery plates having center tapping, providing power from the third or fourth grid from the negative terminal of the battery, and the output voltage being 6-7V or 8-9.33V.

14. A method according to claims 3, wherein the electric pump is used in alcohol fuel motor vehicles with DC output that is higher than 7V and lower than 9V, or higher than 9V and lower than 10.4V.
